(19) United States
(12) Patent Application Publication
(10) Pub. No.: US 2016/0246378 A1
(43) Pub. Date: Aug. 25, 2016

(54) SYSTEMS AND METHODS FOR PROVIDING CONTEXT-SENSITIVE HAPTIC NOTIFICATION FRAMEWORKS

(71) Applicant: Immersion Corporation, San Jose, CA (US)

(72) Inventors: Chad Sampanes, San Jose, CA (US); David Birnbaum, Oakland, CA (US); Iva Segalman, Santa Clara, CA (US); Min Lee, San Jose, CA (US); Christopher Ullrich, Ventura, CA (US)

(21) Appl. No.: 15/052,625

(22) Filed: Feb. 24, 2016

Related U.S. Application Data
(60) Provisional application No. 62/120,687, filed on Feb. 25, 2015.

(51) Int. Cl. G06F 3/01; G06F 3/0482; G06F 3/0484

(52) U.S. Cl. CPC G06F 3/016; G06F 3/04842; G06F 3/0482; G06F 3/04847

(57) ABSTRACT

One disclosed method includes the steps of determining a context of a user device; determining a notification to be provided by the user device; determining a category of the notification; generating a haptic effect based on the category of the notification; and outputting the haptic effect to the user device. Another disclosed method includes the steps of receiving a selection of a category for a haptic effect, the category one of a plurality of predetermined categories of haptic effects; obtaining a plurality of constraints for the haptic effect based on the selected category; receiving an input indicating a characteristic of the haptic effect; determining whether the characteristic violates any of the plurality of constraints; responsive to determining that the characteristic violates at least one of the plurality of constraints, refusing the input; and otherwise, modifying the haptic effect based on the input.

### CROSS-REFERENCE TO RELATED APPLICATIONS

This application claims priority to U.S. Provisional Patent Application No. 62/120,687 entitled “Haptic Notification Framework,” filed Feb. 25, 2015, the entirety of which is hereby incorporated by reference.

### FIELD

The present application generally relates to haptic effects and more specifically relates to providing context-sensitive haptic notification frameworks.

### BACKGROUND

Haptic effects can provide tactile effects to users of devices to provide feedback for a variety of different reasons. For example, video games devices may provide haptic effects to a game player based on events occurring in a video game, such as explosions or weapons firing. In other examples, haptic effects may be provided to simulate physical forces applied to a device. For example, a haptic effect may be applied to a control device for a robotic arm to indicate a resistance to movement of the robotic arm.

### SUMMARY

Various examples are described for context-sensitive haptic notification frameworks. One example method includes the steps of determining a context of a user device; determining a notification to be provided by the user device; determining a category of the notification; generating a haptic effect based on the category of the notification; and outputting the haptic effect to the user device.

Another example method includes the steps of receiving a selection of a category for a haptic effect, the category one of a plurality of predetermined categories of haptic effects; obtaining a plurality of constraints for the haptic effect based on the selected category; receiving an input indicating a characteristic of the haptic effect; determining whether the characteristic violates any of the plurality of constraints; responsive to determining that the characteristic violates at least one of the plurality of constraints, refusing the input; and otherwise, modifying the haptic effect based on the input.

One example system for generating one or more haptic effects includes a non-transitory computer-readable medium and a processor in communication with the non-transitory computer-readable medium, the processor configured to execute program code stored in the non-transitory computer-readable medium to: receive a selection of a category for a haptic effect, the category one of a plurality of predetermined categories of haptic effects; obtain a plurality of constraints for the haptic effect based on the selected category; receive an input indicating a characteristic of the haptic effect; determine whether the characteristic violates any of the plurality of constraints; and responsive to a determination that the characteristic violates at least one of the plurality of constraints, refuse the input.

One example non-transitory computer-readable medium comprising processor-executable program code configured to cause the processor to: receive a selection of a category for a haptic effect, the category one of a plurality of predetermined categories of haptic effects; obtain a plurality of constraints for the haptic effect based on the selected category; receive an input indicating a characteristic of the haptic effect;

determine whether the characteristic violates any of the plurality of constraints; and responsive to a determination that the characteristic violates at least one of the plurality of constraints, refuse the input.

These illustrative examples are mentioned not to limit or define the scope of this disclosure, but rather to provide examples to aid understanding thereof. Illustrative examples are discussed in the Detailed Description, which provides further description. Advantages offered by various examples may be further understood by examining this specification.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1A-1B show an example device for providing context-sensitive haptic notification frameworks;

FIGS. 2-3 show example systems for providing context-sensitive haptic notification frameworks;

FIG. 4 shows an example method for providing context-sensitive haptic notification frameworks;

FIG. 5 shows example categories for an example haptic notification framework; and

FIG. 6 shows an example method for providing context-sensitive haptic notification frameworks.

### DETAILED DESCRIPTION

Examples are described herein in the context of context-sensitive haptic notification frameworks. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Illustrative Example of Context-Sensitive Haptic Notification Frameworks

In one illustrative example, a user carries a smartphone with her during the day to send and receive emails and text messages, surf the web, and play various games. The smartphone is equipped with a haptic output device that can output vibrational haptic effects. While the user is not actively using the smartphone, she carries it in her pocket. At some time during the day, while her smartphone is in her pocket, the smartphone receives a text message from her husband and determines whether to output a notification to the user. In this case, the user has configured to provide notifications based on arriving text messages. Thus, after receiving the text message, the smartphone determines the type of notification to output. In this example, the user has enabled haptic notifications for text messages from her husband and other family members, but not from other contacts. Thus, the smartphone determines that a haptic notification should be output.

The smartphone then determines a category associated with the event, receipt of a text message in this case. To determine the category associated with the event, the smartphone determines whether a default category associated with the event has been assigned. In this case, the default category for a received text message is a “review this” category, which generally corresponds to events that provide messages to the user from another person. Other categories include “now this,” which relates to urgent or time-sensitive events, such as phone calls or alarms; “do this,” which relates to actions a user should take, such as following a navigation route or changing an operating speed of a vehicle; “know this,” which relates to information provided to the user, such as reminders or alerts, such as a low batteries or Amber alerts; or “changed this,” which relate to changing device status, such as changing a mode of operation, or changing contexts, such as entering a meeting.

After determining the category, the smartphone then determines whether a device context or other information, such as the contents of the text message, warrant a change in category. In this case, the contents of the text message indicate that the user's husband is running late. In addition, the smartphone determines that it is located in the user's pocket, based on an amount of light captured by the camera and the smartphone's orientation. Based on this information, the smartphone determines that the content of the text message is not time-sensitive and that the smartphone's location is likely to result in effective transmission of haptic effects to the user. Thus, the smartphone determines that the “know this” category is appropriate.

The smartphone then generates a haptic effect. In this case, the smartphone accesses a library of available haptic effects and selects a haptic effect associated with text messages. The smartphone then adjusts the strength and duration of the haptic effect based on the “know this” category. In this example, “know this” haptic effects are configured to have a high amplitude and to have a medium-length duration. Thus, the smartphone determines the strength of the accessed haptic effect and, finding that the haptic effect has only a moderate strength, scales up the strength of the haptic effect by doubling its magnitude. In addition, the smartphone determines that the accessed haptic effect only has a short duration, and therefore extends the duration of the haptic effect by repeating the haptic effect twice. By changing these characteristics of the haptic effect, the smartphone has generated a new haptic effect, and outputs the new haptic effect.

After noticing the haptic effect, the user recognizes the tactile sensation as relating to a “know this” event, and retrieves the smartphone from her pocket and reviews the text message. She then responds to the text message and put the smartphone on a table. Shortly thereafter, the smartphone's battery drops below 20% charge and the smartphone generates a “low battery” notification. The smartphone then determines a “know this” category associated with the “low battery” notification, but based on the devices unmoving, horizontal orientating, the smartphone determines that it is at rest on a surface, and determines a stronger effect should be output. Thus, the smartphone determines that the strength of a haptic effect should be scaled up to the maximum strength allowed for the category. The smartphone then accesses the haptic effect library, obtains a suitable haptic effect, and increases the strength of the selected haptic effect. The haptic effect in this case corresponds to the constraints of “know this” haptic effects, and so the smartphone outputs the haptic effect. The effect causes a vibration of the smartphone and draws the user's attention to it, at which time, the user reads the notification and plugs the smartphone into a charger.

This illustrative example is not intended to be in any way limiting, but instead is intended to provide an introduction to the subject matter of the present application. For example, the illustrative example above is described with respect to a smartphone; however, the present application is not limited to such a device, but may be used in any suitable device. Other examples of context-sensitive haptic notification frameworks are described below.

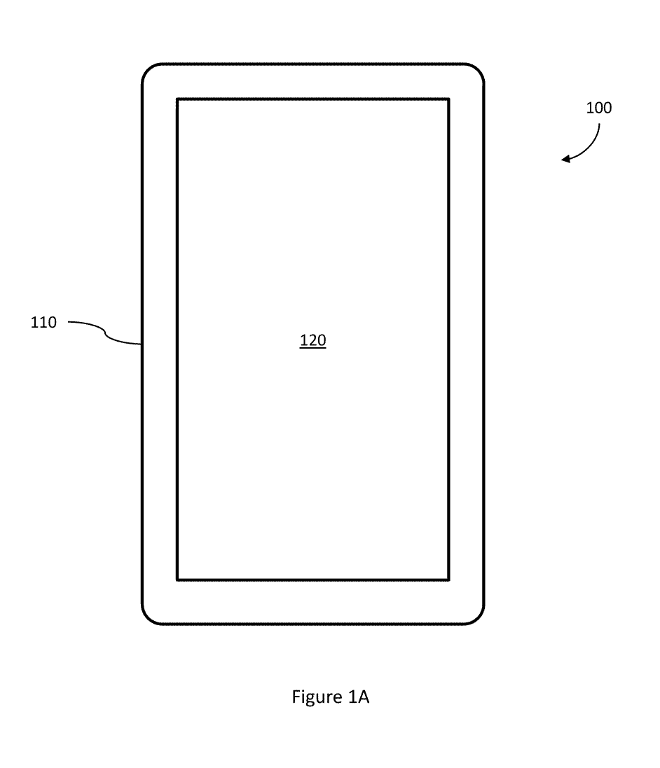

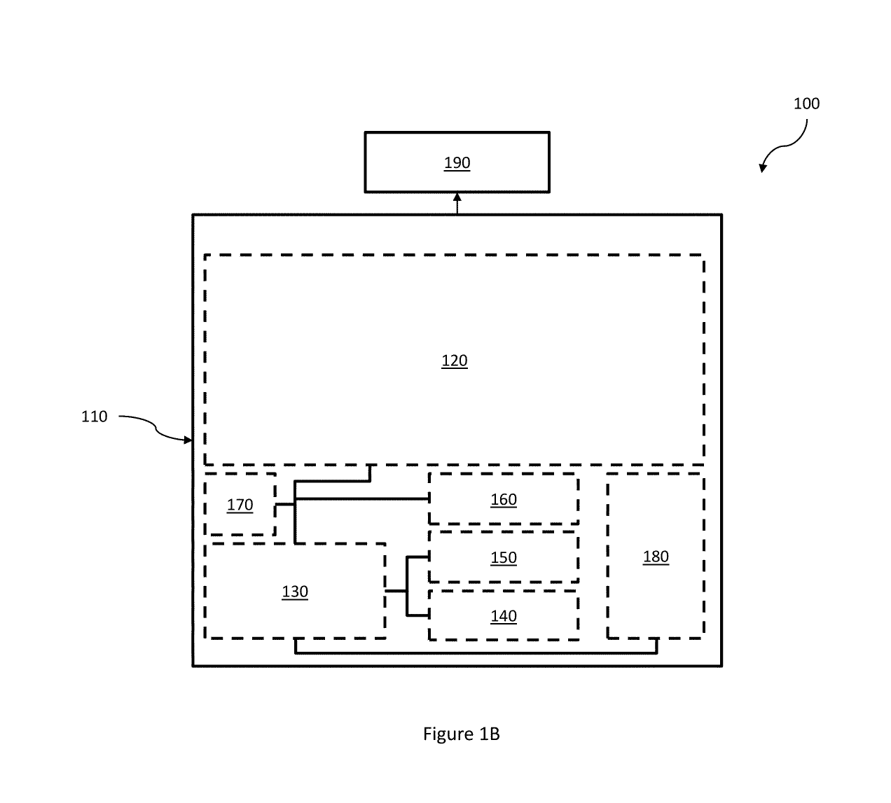

Referring now to FIGS. 1A and 1B, FIGS. 1A and 1B illustrate an example device 100 for providing context-sensitive haptic notification frameworks. In the example shown in FIG. 1A, the device 100 includes a tablet 110 that has a touch-sensitive display screen 120 and a haptic output device (not shown) that is capable of outputting vibrational effects to the tablet's housing.

Referring now to FIG. 1B, FIG. 1B shows an example device for providing context-sensitive haptic notification frameworks. In the example shown in FIG. 1B, the device 100 comprises a housing 110, a processor 130, a memory 160, a touch-sensitive display 120, a haptic output device 140, one or more sensors 150, one or more communication interfaces 180, and one or more speakers 170. In addition, the device 100 is in communication with haptic output device 190, which may be optionally coupled to or incorporated into some examples. The processor 130 is in communication with the memory 160 and, in this example, both the processor 130 and the memory 160 are disposed within the housing 110. The touch-sensitive display 120, which comprises or is in communication with a touch-sensitive surface, is partially disposed within the housing 110 such that at least a portion of the touch-sensitive display 120 is exposed to a user of the device 100. In some examples, the touch-sensitive display 120 may not be disposed within the housing 110. For example, the device 100 may be connected to or otherwise in communication with a touch-sensitive display 120 disposed within a separate housing. In some example, the housing 110 may comprise two housings that may be slidably coupled to each other, pivotably coupled to each other or releasably coupled to each other.

In the example shown in FIG. 1B, the touch-sensitive display 120 is in communication with the processor 130 and is configured to provide signals to the processor 130 or the memory 160 and to receive signals from the processor 130 or memory 160. The memory 160 is configured to store program code or data, or both, for use by the processor 130, which is configured to execute program code stored in memory 160 and to transmit signals to and receive signals from the touch-sensitive display 120. In the example shown in FIG. 1B, the processor 130 is also in communication with the communication interface 180 and is configured to receive signals from the communication interface 180 and to output signals to the communication interface 180 to communicate with other components or devices such as one or more remote computers or servers. In addition, the processor 130 is in communication with haptic output device 140 and haptic output device 190, and is further configured to output signals to cause haptic output device 140 or haptic output device 190, or both, to output one or more haptic effects. Furthermore, the processor 130 is in communication with speaker 170 and is configured to output signals to cause speaker 170 to output sounds. In various examples, the device 100 may comprise or be in communication with fewer or additional components or devices. For example, other user input devices such as a mouse or a keyboard, or both, or an additional touch-sensitive device may be comprised within the device 100 or be in communication with the device 100. As another example, device 100 may comprise and/or be in communication with one or more accelerometers, gyroscopes, digital compasses, and/or other sensors. A detailed description of the components of the device 100 shown in FIG. 1B and components that may be in association with the device 100 are described herein.

The device 100 can be any device that is capable of receiving user input and executing software applications. For example, the device 100 in FIG. 1B includes a touch-sensitive display 120 that comprises a touch-sensitive surface. In some examples, a touch-sensitive surface may be overlaid on the touch-sensitive display 120. In other examples, the device 100 may comprise or be in communication with a display and a separate touch-sensitive surface. In still other examples, the device 100 may comprise or be in communication with a display and may comprise or be in communication with other user input devices, such as a mouse, a keyboard, buttons, knobs, slider controls, switches, wheels, rollers, joysticks, other manipulanda, or a combination thereof.

In some examples, one or more touch-sensitive surfaces may be included on or disposed within one or more sides of the device 100. For example, in one example, a touch-sensitive surface is disposed within or comprises a rear surface of the device 100. In another example, a first touch-sensitive surface is disposed within or comprises a rear surface of the device 100 and a second touch-sensitive surface is disposed within or comprises a side surface of the device 100. In some examples, the system may comprise two or more housing components, such as in a clamshell arrangement or in a slidable arrangement. For example, one example comprises a system having a clamshell configuration with a touch-sensitive display disposed in each of the portions of the clamshell. Furthermore, in examples where the device 100 comprises at least one touch-sensitive surface on one or more sides of the device 100 or in examples where the device 100 is in communication with an external touch-sensitive surface, the display 120 may or may not comprise a touch-sensitive surface. In some examples, one or more touch-sensitive surfaces may have a flexible touch-sensitive surface. In other examples, one or more touch-sensitive surfaces may be rigid. In various examples, the device 100 may comprise both flexible and rigid touch-sensitive surfaces.

In various examples, the device 100 may comprise or be in communication with fewer or additional components than the example shown in FIG. 1B. For example, in one example, the device 100 does not comprise a speaker 170. In another example, the device 100 does not comprise a touch-sensitive display 120, but comprises a touch-sensitive surface and is in communication with a display. Thus, in various examples, the device 100 may comprise or be in communication with any number of components, such as in the various examples disclosed herein as well as variations that would be apparent to one of skill in the art.

The housing 110 of the device 100 shown in FIG. 1B provides protection for at least some of the components of device 100. For example, the housing 110 may be a plastic casing that protects the processor 130 and memory 160 from environmental conditions, such as rain, dust, etc. In some examples, the housing 110 protects the components in the housing 110 from damage if the device 100 is dropped by a user. The housing 110 can be made of any suitable material including but not limited to plastics, rubbers, or metals. Various examples may comprise different types of housings or a plurality of housings. For example, in some examples, the device 100 may be a portable device, handheld device, toy, gaming console, handheld video game system, gamepad, game controller, desktop computer, e-book reader, portable multifunction device such as a cell phone, smartphone, personal digital assistant (PDA), laptop, tablet computer, digital music player, etc.

In some examples, the device 100 may be embedded in another device such as a wrist watch, a virtual-reality headset, other jewelry, such as bracelets, wristbands, rings, earrings, necklaces, etc., gloves, eyeglasses, augmented-reality (“AR”) devices, such as AR headsets, or other wearable device. Thus, in some examples, the device 100 is wearable. In one example, the device 100, such as a wearable device, does not comprise a display screen, but instead may comprise one or more notification mechanisms, such as one or more lights, such as one or more individual LEDs, one or more haptic output devices, one or more speakers, etc. Such a device 100 may be configured to generate one or more notifications to a user using one or more such notification mechanisms.

In the example shown in FIG. 1B, the touch-sensitive display 120 provides a mechanism to allow a user to interact with the device 100. For example, the touch-sensitive display 120 detects the location or pressure, or both, of a user's finger in response to a user hovering over, touching, or pressing the touch-sensitive display 120 (all of which may be referred to as a contact in this disclosure). In one example, a contact can occur through the use of a camera. For example, a camera may be used to track a viewer's eye movements as the user views the content displayed on the display 120 of the device 100, or the user's eye movements may be used to transmit commands to the device, such as to turn a page or to highlight a portion of text. In this example, haptic effects may be triggered based at least in part on the viewer's eye movements. For example, a haptic effect may be output when a determination is made that the viewer is viewing content at a particular location of the display 120. In some examples, the touch-sensitive display 120 may comprise, be connected with, or otherwise be in communication with one or more sensors that determine the location, pressure, size of a contact patch, or any of these, of one or more contacts on the touch-sensitive display 120.

In some examples, the touch-sensitive display 120 may comprise a multi-touch touch-sensitive display that is capable of sensing and providing information relating to a plurality of simultaneous contacts. For example, in one example, the touch-sensitive display 120 comprises or is in communication with a mutual capacitance system. Some examples may have the ability to sense pressure or pseudo-pressure and may provide information to the processor associated with a sensed pressure or pseudo-pressure at one or more contact locations. In another example, the touch-sensitive display 120 comprises or is in communication with an absolute capacitance system. In some examples, the touch-sensitive display 120 may comprise or be in communication with a resistive panel, a capacitive panel, infrared LEDs, photodetectors, image sensors, optical cameras, or a combination thereof. Thus, the touch-sensitive display 120 may incorporate any suitable technology to determine a contact on a touch-sensitive surface such as, for example, resistive, capacitive, infrared, optical, thermal, dispersive signal, or acoustic pulse technologies, or a combination thereof.

In the example shown in FIG. 1B, haptic output device 140 and haptic output device 190 are in communication with the processor 130 and are configured to provide one or more haptic effects. For example, in one example, when an actuation signal is provided to haptic output device 140, haptic output device 190, or both, by the processor 130, the respective haptic output device(s) 140, 190 outputs a haptic effect based on the actuation signal. For example, in the example shown, the processor 130 is configured to transmit a haptic output signal to haptic output device 140 comprising an analog drive signal. In some examples, the processor 130 is configured to transmit a high-level command to haptic output device 190, wherein the command includes a command identifier and zero or more parameters to be used to generate an appropriate drive signal to cause the haptic output device 190 to output the haptic effect. In other examples, different signals and different signal types may be sent to each of one or more haptic output devices. For example, in some examples, a processor may transmit low-level drive signals to drive a haptic output device to output a haptic effect. Such a drive signal may be amplified by an amplifier or may be converted from a digital to an analog signal, or from an analog to a digital signal using suitable processors or circuitry to accommodate the particular haptic output device being driven.

A haptic output device, such as haptic output device 190, can be any component or collection of components that is capable of outputting one or more haptic effects. For example, a haptic output device can be one of various types including, but not limited to, an eccentric rotational mass (ERM) actuator, a linear resonant actuator (LRA), a piezoelectric actuator, a voice coil actuator, an electro-active polymer (EAP) actuator, a shape memory alloy, a pager, a DC motor, an AC motor, a moving magnet actuator, a smartgel, an electrostatic actuator, an electrotactile actuator, a deformable surface, an electrostatic friction (ESF) device, an ultrasonic friction (USF) device, or any other haptic output device or collection of components that perform the functions of a haptic output device or that are capable of outputting a haptic effect. Multiple haptic output devices or different-sized haptic output devices may be used to provide a range of vibrational frequencies, which may be actuated individually or simultaneously. Various examples may include a single or multiple haptic output devices and may have the same type or a combination of different types of haptic output devices.

In other examples, deformation of one or more components can be used to produce a haptic effect. For example, one or more haptic effects may be output to change the shape of a surface or a coefficient of friction of a surface. In an example, one or more haptic effects are produced by creating electrostatic forces and/or ultrasonic forces that are used to change friction on a surface. In other examples, an array of transparent deforming elements may be used to produce a haptic effect, such as one or more areas comprising a smartgel. Haptic output devices also broadly include non-mechanical or non-vibratory devices such as those that use electrostatic friction (ESF), ultrasonic surface friction (USF), or those that induce acoustic radiation pressure with an ultrasonic haptic transducer, or those that use a haptic substrate and a flexible or deformable surface, or those that provide projected haptic output such as a puff of air using an air jet, and so on. In some examples comprising haptic output devices, such as haptic output device 190, that are capable of generating frictional or deformation effects, the haptic output device may be overlaid on the touch-sensitive display or otherwise coupled to the touch-sensitive display 120 such that the frictional or deformation effects may be applied to a touch-sensitive surface that is configured to be touched by a user. In some examples, other portions of the system may provide such forces, such as portions of the housing that may be contacted by the user or in a separate touch-separate input device coupled to the system. Co-pending U.S. patent application Ser. No. 13/092,484, filed Apr. 22, 2011, entitled “Systems and Methods for Providing Haptic Effects,” the entirety of which is hereby incorporated by reference, describes ways that one or more haptic effects can be produced and describes various haptic output devices.

It will be recognized that any type of input synthesis method may be used to generate the interaction parameter from one or more haptic effect signals including, but not limited to, the method of synthesis examples listed in TABLE 1 below.

TABLE 1
METHODS OF SYNTHESIS

| Synthesis Method | Description |
|---|---|
| Additive synthesis | combining inputs, typically of varying amplitudes |
| Subtractive synthesis | filtering of complex signals or multiple signal inputs |
| Frequency modulation | modulating a carrier wave signal with one or more operators |
| synthesis | |
| Sampling | using recorded inputs as input sources subject to modification |
| Composite synthesis | using artificial and sampled inputs to establish a resultant |
| | “new” input |
| Phase distortion | altering the speed of waveforms stored in wavetables during |
| | playback |
| Waveshaping | intentional distortion of a signal to produce a modified result |
| Resynthesis | modification of digitally sampled inputs before playback |
| Granular synthesis | combining of several small input segments into a new input |
| Linear predictive coding | similar technique as used for speech synthesis |
| Direct digital synthesis | computer modification of generated waveforms |
| Wave sequencing | linear combinations of several small segments to create a new input |
| Vector synthesis | technique for fading between any number of different input |
| | sources |
| Physical modeling | mathematical equations of the physical characteristics of |
| | virtual motion |

In the example device in FIG. 1B, the sensor 150 is configured to generate one or more sensor signals that may be used to determine a location of the device 100. For example, the sensor 150 may comprise a GPS receiver. In some examples, the sensor 150 may be a WiFi component that is capable of receiving WiFi signals and providing those signals to the processor 130. In some examples, the sensor 150 may be one or more accelerometers or gyroscopes configured to detect a movement of the device 100, or one or more image or light sensors configured to detect ambient light levels or capture images.

In the example device in FIG. 1B, the communication interface 180 is in communication with the processor 130 and provides wired or wireless communications from the device 100 to other components or other devices. For example, the communication interface 180 may provide wireless communications between the device 100 and a communications network. In some examples, the communication interface 180 may provide communications to one or more other devices, such as another device 100 and/or one or more other devices. The communication interface 180 can be any component or collection of components that enables the device 100 to communicate with another component, device, or network. For example, the communication interface 180 may comprise a PCI communication adapter, a USB network adapter, or an Ethernet adapter. The communication interface 180 may communicate using wireless Ethernet, including 802.11 a, g, b, or n standards. In one example, the communication interface 180 can communicate using Radio Frequency (RF), Bluetooth, CDMA, TDMA, FDMA, GSM, Wi-Fi, satellite, or other cellular or wireless technology. In other examples, the communication interface 180 may communicate through a wired connection and may be in communication with one or more networks, such as Ethernet, token ring, USB, FireWire 1394, fiber optic, etc. In some examples, device 100 comprises a single communication interface 180. In other examples, device 100 comprises two, three, four, or more communication interfaces.

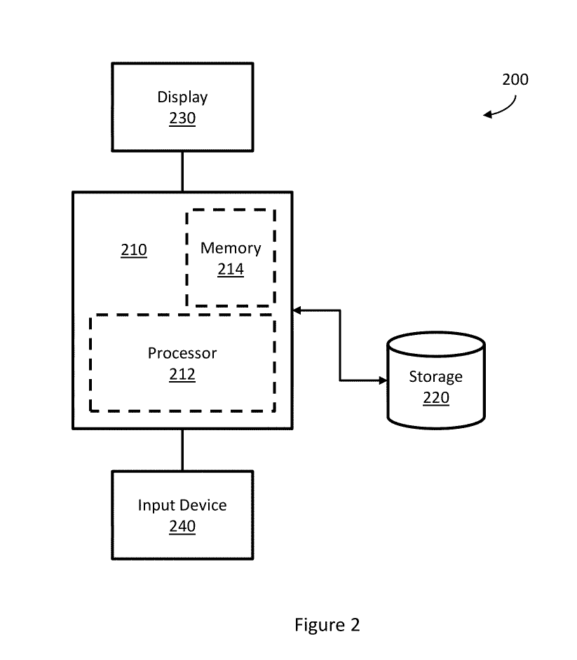

Referring now to FIG. 2, FIG. 2 shows an example system 200 for providing context-sensitive haptic notification frameworks according to this disclosure. The system 200 shown in FIG. 2 includes a computing device 210, which includes a processor 212 and a memory 214. The computing device 210 is in communication with a display 230 and an input device 240, as well as storage device 220.

In the example shown in FIG. 2, the processor 212 is in communication with memory 214 and is configured to execute a software application enables providing context-sensitive haptic notification frameworks according to this disclosure. The software application may be stored within the memory 214 or in another memory, either local to or remote from the computing device 210. The software application, as will be described in greater detail below, is configured to receive input information from the input device or processor, provide display signals to the processor or the display, and to configured one or more haptic effects according to a haptic notification framework, including related constraints.

In different examples, suitable input devices may be employed. For example, an input device 240 may be a conventional keyboard and mouse, or it may include a touch-sensitive input device. A touch-sensitive tablet may generate one or more signals based on interactions with a control object, such as a user's finger or a stylus, and provide those signals to the computer 210. The signals may include position information related to an interaction between the control object and the touch-sensitive tablet, pressure or pseudo-pressure information related to the interaction, velocity or acceleration information related to the interaction, or other parameters associated with the interaction. In some examples, the touch-sensitive tablet may be responsive to contact with other objects, including a user's finger, or multiple substantially simultaneous contacts with one or more objects, such as multiple fingers.

In some examples, the touch-sensitive input device may be integrated into the computer 210. For example, in one example, the computer 210 comprises a tablet computer, such as an Apple® iPad®, having a touch-sensitive input device overlaid on the tablet computer's display. In another example, the computer 210 may comprise a laptop device with an integral display and a touch-sensitive input device overlaid on the display.

Signals from the input device 240 may be transmitted to the computing device 210 via a communications bus, such as USB, FireWire, or other suitable communications interface. The processor 212 is also in communication with storage device 220, which is configured store data. In some examples, the storage device 220 comprises a non-volatile computer readable medium, such as a hard disk, coupled to or disposed within the computer. In some examples, the storage device 220 is remote from the computing device 210, such as a network-connected hard disk or a remote database system. In some examples, the processor 212 is configured to generate a file to store data, such as data received from the input device 240, in the storage device 220.

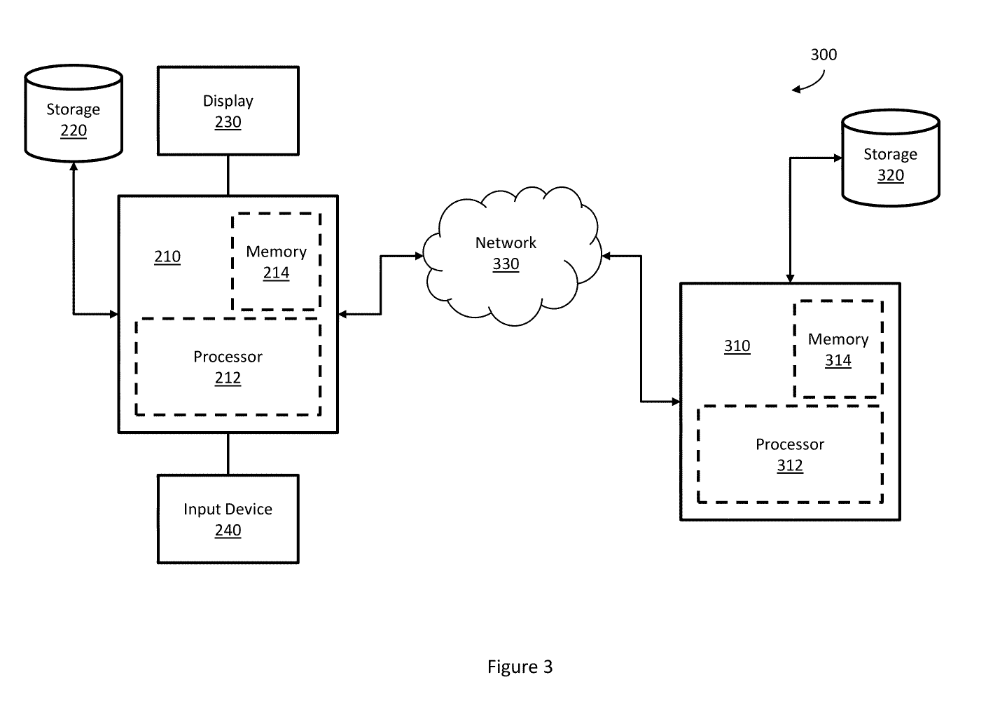

Referring now to FIG. 3, FIG. 3 shows a system 300 for providing context-sensitive haptic notification frameworks according to this disclosure. The system 300 shown in FIG. 3 comprises a first computing device 210, such as the computing device 210 described above with respect to FIG. 2. In addition, the computing device 210 is in communication with a second computing device 310 via network 330. In the example shown in FIG. 3, the second computing device 310 includes a processor 312 and a computer-readable medium 314, and is in communication with storage device 330.

In the example shown in FIG. 3, the first computing device 210 is configured to execute a front end for a software application for providing context-sensitive haptic notification frameworks according to this disclosure, and the second computing device 310 is configured to execute processing for the software application for providing context-sensitive haptic notification frameworks according to this disclosure. For example, the first computing device 210 receives input signals from the input device and transmit a signal to the second computing device 310 based on the input signals. The processor 312 in the second computing device is configured to receive the input signals and to determine actions responsive to the input signals. The second computing device 312 then generates one or more signals to transmit to the first computing device 210 based on the determined actions. The processor 212 at the first computing device 210 receives the signals from the second computing device 310 and provides information via the display 230.

The example computing devices and environments shown above with respect to FIGS. 1A-3, as well as others according to this disclosure may be suitable for use with one or more methods according to this disclosure, some examples of which are described in more detail below.

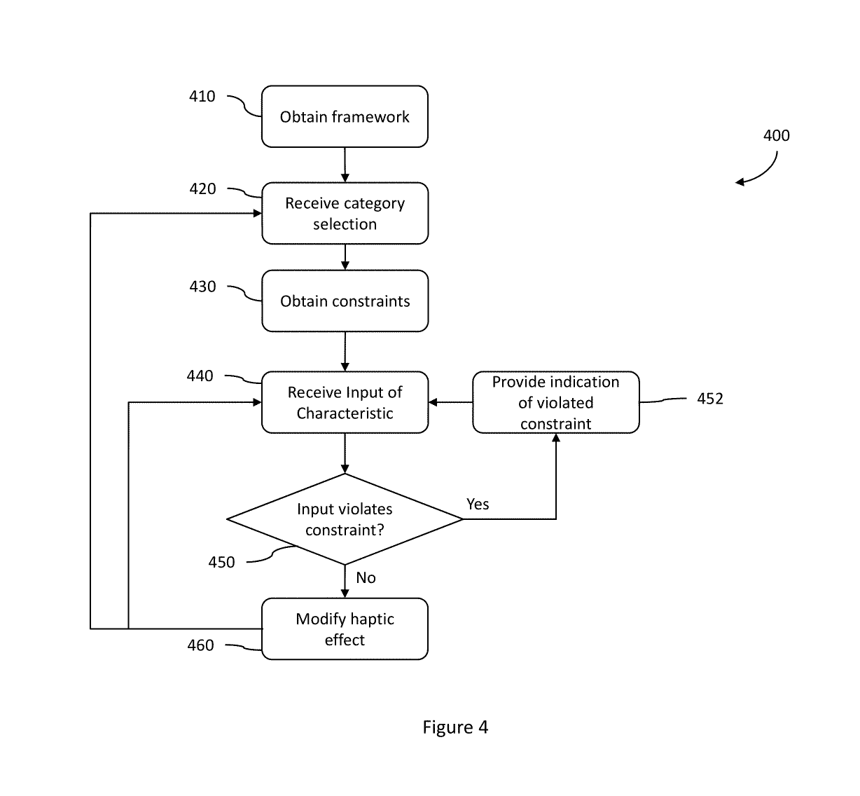

Referring now to FIG. 4, FIG. 4 shows an example method 400 for providing context-sensitive haptic notification frameworks. This example illustrates a method for creating or modifying one or more haptic effects according to a haptic notification framework. The method 400 of FIG. 4 will be discussed with respect to a software application executed by the computing device 210 of FIGS. 2 and 3. However, other suitable computing devices, such as the device 100 shown in FIGS. 1A-1B, may perform such a method as well. The method 400 of FIG. 4 begins at block 410.

At block 410, a haptic notification framework design application (or “design application”) executed by the computing device 210 obtains a haptic notification framework (or “framework”). The framework may provide constraints on haptic effects to enable different types of haptic effects to have different, but easily identifiable, characteristics that may allow a user to learn to distinguish the feel of different types of effects, and to distinguish different effects within each different type. Thus, the framework may provide a foundation upon which a haptic “language” may be developed. Frameworks include categories of haptic effects, and can include the haptic effects themselves. Though in some examples, the framework may only include the categories, and may then search for appropriate available haptic effects as they are needed based on the characteristics of the respective categories.

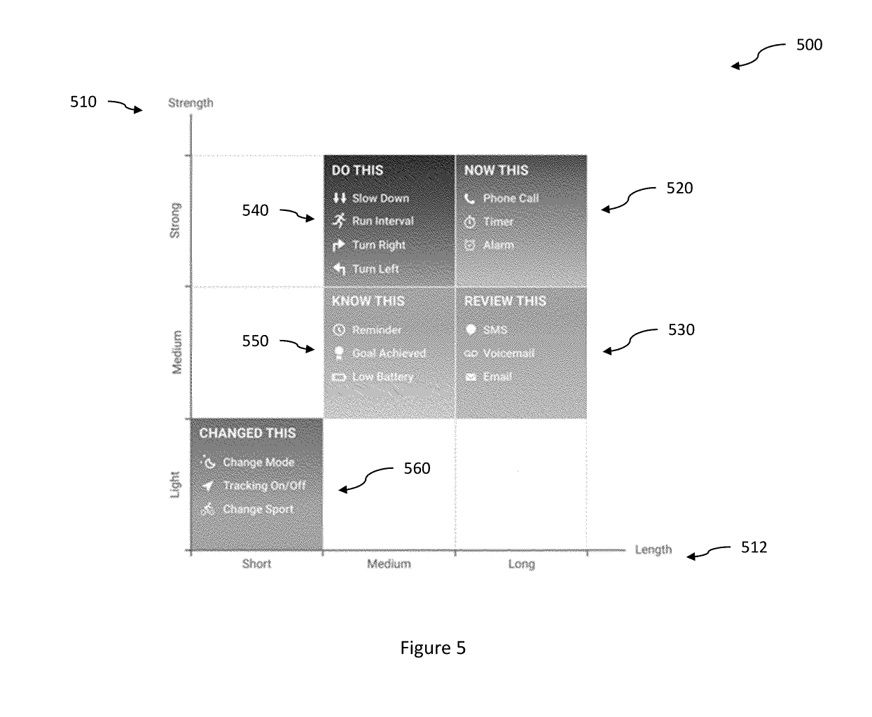

For example, referring to FIG. 5, shows an example of categories for an example haptic notification framework 500 according to this disclosure. In this example, the framework 500 includes five different categories of effects: a “now this” category, a “do this” category, a “review this” category, a “know this” category, and a “changed this” category. Each category may be associated with one or more different types of events or notifications. Such information may be maintained within the haptic notification framework, though in some examples, such information may be maintained separately from the framework and externally-established associations may be used to tie an event or notification to a particular category.

As is illustrated in FIG. 5, each category is associated with a range of haptic characteristics, including strength and length (or duration). For example, the “now this” category includes effects having high strength and long duration. As can be seen, a “now this” effect may have any strength within the “strong” range, and any duration within the “long” duration. However, the framework prohibits “now this” effects from having a medium or low strength, or a short or medium duration. Instead, other categories provide haptic effects having different combinations of strength and duration. Thus, a haptic effect defined according to a particular category must possess characteristics within the constraints defined by the framework. Though it should be noted that other characteristics may not be bounded. For example, a haptic effect may have a large number of characteristics: frequency, magnitude, duration, rhythm, frequency envelopes, repetition, and others. Each of these may be constrained in different ways according to different example frameworks. And while not all characteristics must be constrained in every framework, a least one characteristic must have enough constraints to provide for at least two categories of haptic effects.

In this example, the categories correspond to the following ranges of values:

TABLE 2

| | Low | Medium | High |
|---|---|---|---|
| Duration | 0-0.5 seconds | 1-4 seconds | >4 seconds |
| Intensity | 0-6,000 | 6,000-8,000 | 8,000-10,000 |

Intensity values relate to a scale based on the haptic output capabilities of a haptic output device, of a driving signal, or other haptic output capabilities. For example, an intensity of 0 may refer to a minimum intensity, while an intensity of 10,000 may relate to a maximum intensity. Suitable ranges may be used for other categories as well, for example, a density characteristic may have low, medium, and high ranges of 0-20%, 20-60%, and 60-100% respectively. In some examples, density relates to the interval with respect to a particular time period at which the haptic effect is output. In some examples, a frequency envelope may be employed to generate a haptic effect having a frequency greater than or less than a frequency output by a haptic output device. For example, a vibrational actuator may be able to output vibrations in the range of 400-1,000 Hz, but may be able to output an apparently lower frequency vibration, e.g., 100 Hz, by modulating the amplitude of a higher frequency signal at a rate of 100 Hz.

Further, in the example shown in FIG. 5, categories do not overlap with respect to strength or duration; however, in some examples, categories may overlap with respect to one or more characteristics. It should be noted that while some overlap may be allowed, at least one characteristic for each category must be constrained in a way that is entirely mutually exclusive of all other categories. For example, a framework may constrain haptic effects based on strength, duration, and frequency. However, while the framework may allow overlap in frequencies between categories, the framework strictly constrains the categories by strength and duration such that no categories overlap with respect to strength and duration (i.e., they are mutually-exclusive with respect to these characteristics). Absent such constraints, a user may not be able to easily distinguish between haptic effects in different categories.

In this example, the design application accesses a data file stored in the data storage device 220 and retrieves the framework from the data file. In some examples, the design application may obtain the framework from a remote storage device, such as storage device 320 or the design application may communicate with a remote computing device 310 that maintains or has the framework. For example, the design application may execute a front-end GUI for use by a user at computing device 210, while user inputs are transmitted to the remote computing device 310 for use with the remotely-managed framework.

In some examples, the design application may allow a user to create a new framework. One example design application may present the user with a GUI that enables a user to define one or more categories, and for each category, the user may define one or more constraints. The design application may then validate the framework to ensure that each category includes at least one characteristic that is mutually-exclusive from every other category. As discussed above, while some categories may overlap with one another in one or more characteristics, each category must have at least one characteristic that is mutually exclusive from all other categories.

To validate a category in this example, the design application accesses the characteristics of the new category and compares each against corresponding characteristics of every other category in the framework. For each comparison, the design application determines whether the characteristics overlap, e.g., a frequency range of the characteristic overlaps with a frequency range of another characteristic, or are equal. After comparing each of the characteristics, the design application determines which characteristics are mutually-exclusive of the corresponding characteristics of every other category. Or in some examples, the design application may stop the comparisons once a mutually-exclusive characteristic is found. But, if at least one characteristic is mutually exclusive, the design application validates the category. If no characteristics are mutually-exclusive of the other categories in the framework, the design application outputs a notification indicating that at least one characteristic must be modified. In some examples, the design application may also output additional information to assist the user, such as indicating, for each characteristic, which other category (or categories) the new category overlaps with. It should be noted that such information may be provided even if the new category is validate.

The user may then create additional categories for the framework, with the requirement that the framework must include at least two categories.

After obtaining the framework, such as by retrieving it from a data file or database, or by creating a new framework, as described above, the method 400 proceeds to block 420.

At block 420, the design application receives a selection of a category for a haptic effect, the category one of a plurality of predetermined categories of haptic effects. For example, the user may desire to create a new haptic effect, or to import a haptic effect into the framework. As discussed above, a framework includes a plurality of categories, each of which is mutually-exclusive of every other category in at least one characteristic. For example, the design application may present to the user, via the display device 230, a GUI showing the available categories in a framework and, in some examples, the option to create a new category as described above with respect to block 410. In some examples, the design application may present the user with a graphical representation of the available categories arranged in a way to highlight their differences. For example, the design application may display a Cartesian coordinate system in one or more dimensions, such as may be seen in FIG. 5, to show the different categories and one or more of their respective mutually-exclusive characteristics. Other example graphical illustrations may include Venn diagrams where the user can select one or more characteristics to cause the GUI to present dynamic views of overlaps between the categories.

To select a category, the user uses the input device 240 to select the desired category. For example, the user may touch a touch screen at a location corresponding to a desired category, or may use a mouse to move a cursor over a desired category, such as the “now this” category 520 of the example graphical representation of a framework in FIG. 5, and click a button.

At block 430, the design application obtains a plurality of constraints for the haptic effect based on the selected category. For example, as discussed above, the framework may be stored in a variety of locations, locally or remotely, or may be maintained entirely by a remote computing device 310. To obtain the constraints, the design application may access information associated with the selected category, or it may transmit information to a remote computing device 310 to indicate the selected category to cause the remote computing device 310 to access the constraints for the selected category.

At block 440, the design application receives an input indicating a characteristic of the haptic effect. For example, the user may create a new haptic effect or may modify an existing haptic effect. The design application may present a GUI interface to create a new haptic effect and allow the user to select characteristics of the new haptic effect, e.g., strength, duration, frequency, or others. The user may select a characteristic to add the characteristic to the new haptic effect. The user may then enter one or more values for the characteristic. For example, the may select a strength characteristic to add to the haptic effect and may then select “strong” or may input a strength value. For example, a strength value may comprise an amplitude of an actuator signal or a desired amplitude of an output vibration. The latter may be employed in one or more user device in which software dynamically adjusts haptic effects based on known characteristics of actuators within the user device. Or, if the user is modifying an existing haptic effect, the user may select an existing characteristic of the existing haptic effect and enter a new value or range for the characteristic.

At block 450, the design application determines whether the characteristic violates any of the plurality of constraints. For example, as discussed above, the user has selected the “now this” category 520 for the effect. If the user enters a strength characteristic of “medium,” as can be seen in FIG. 5, the “now this” category 520 is constrained to effects with “strong” strength characteristics. Thus, the design application determines that the entered characteristic violates one of the “now this” category's constraints and outputs a notification to the user indicating the constraint violation. The design application may compare characteristics with constraints as appropriate for the respective constraint. For example, a constraint may include a range of values, and so the design application may determine whether the inputted characteristic falls within the range of values for the appropriate constraint. If the inputted characteristic violates a constraint, the method 400 proceeds to block 452, otherwise, the method 400 proceeds to block 460.

At block 452, in this example, the design application displays an indication of the constraint that was violated. In some examples, the design application may also provide a tooltip or other assistive information indicating the applicable constraints for the category. The method 400 then returns to block 440.

At block 460, the design application modifies the haptic effect. For example, the design application may maintain in memory 214 of the computing device 210 characteristics for the new or modified haptic effect. After modifying the haptic effect, the design application may store the modified haptic effect in a data store, e.g., data store 220 or data store 320. In some examples, the design application may wait to store the new or modified haptic effect until a user provides a command to save the haptic effect. After modifying the haptic effect, the method 400 may return to block 420 to receive a category selection for a different haptic effect, or it may return to block 440 to receive another characteristic input.

It should be noted that the ordering of the steps discussed above is not indicative of the only ordering of steps for the method 400. In some examples, steps may be performed in different orders or substantially simultaneously. For example, block 440 may be performed prior to block 420. In one example, a user may define a haptic effect, or may import an existing haptic effect, in the design application and then later select a category for the effect, at which time the design application may obtain the corresponding constraints and determine whether any of the haptic effect's characteristics violate the constraints. In some examples, certain blocks may not be performed, such as block 452, or certain steps may be performed multiple times prior to subsequent steps. For example, block 440 may be performed multiple times to receive multiple input characteristics before determining whether any violate any constraints at block 450.

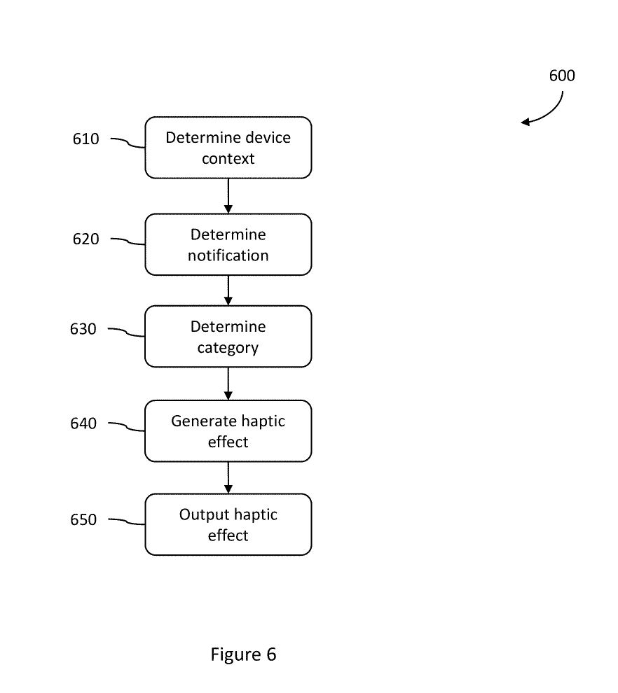

Referring now to FIG. 6, FIG. 6 shows an example method 600 for providing context-sensitive haptic notification frameworks. This example illustrates a method for outputting haptic effects according to a haptic notification framework. The method 600 of FIG. 6 will be discussed with respect to a software application executed by the device 100 of FIGS. 1A-1B. However, other suitable computing devices, such as the computing device 210 shown in FIGS. 2-3, may perform such a method as well. The method 600 of FIG. 6 begins at block 610.

At block 610, a context engine determines a context of a user device 100. A context refers to a state of the user device 100, such as an operating environment (e.g., a noisy environment; a meeting; or a moving environment, such as in a car or other vehicle), a location of the device 100 with respect to the user, (e.g., in the user's hand, in the user's pocket, or on a table or other flat surface), an operating mode of the device 100 (e.g., phone call, executing a gaming application, or idle), or other state of the device 100. For example, the software application employs sensors, such as accelerometers or image sensors, or other sensed information, such as GPS or WiFi locationing information, to determine a device context. The user device 100 may employ accelerometers to determine that a device 100 is located in a user's pocket based on repetitive motion indicative of walking, or based on a sustained vertical orientation, e.g., an upside-down vertical orientation, or image sensor data indicating a dark environment. In some examples, the device 100 may determine that it is in an environment with high levels of ambient vibrations, such as on a train or a bus.

At block 620, the user device 100 determines a notification to be provided by the user device. For example, if the user device 100 receives a phone call, the user device 100 may determine a “ring” notification to be provided. Other types of notifications may be based on detected events, such as expiration of a timer or an alarm; reminders, such as calendar appointments or virtual sticky-notes; incoming messages, such as emails, text messages, or voice mails; achievements, such as a number of steps accomplished, a number of miles run, a heart-rate goal, a glucose level reached, or other predetermined goal; device information, such as a low battery, loss of WiFi connection, loss of cellular connection, or data usage limits reached; changes in operating modes, such as to a quiet mode, to an idle mode, or to a video call mode. Still other types of notifications may be employed based on any other type of event.

Notifications according to this disclosure may be displayed as textual or graphical notifications displayed on a display 120 of the device 100, or provided as one or more haptic effects output by a haptic output device 140, 190.

At block 630, the user device 100 determines a category of the notification. As discussed above, a haptic notification framework includes categories that may be associated with different types of events or notifications. In this example, the haptic notification framework includes a variety of different event and notification identifiers that may correspond to events detected or notifications generated by the user device 100. For example, a software application on the user device 100 may use the determined notification to identify a corresponding notification identifier in the framework.

In some examples, the user device 100 may analyze content of a received message or notification. For example, the user device 100 may receive an email message or other text message and analyze the contents to determine a level of urgency of the message. For example, the user device 100 may search for terms like “urgent” or “deadline” or “emergency” to determine whether the message includes urgently-needed information. In some examples, the user device 100 may employ natural language processing to determine semantic content of the message to determine whether the message relates to important subject matter. If the message is determined to be important, the user device 100 may select a “now this” category 520, but otherwise may select a “review this” category 530.

At block 640, the user device 100 generates a haptic effect based on the category of the notification. In this example, the haptic notification framework includes a variety of different haptic effects, each associated with a particular category. Thus, once a category for a notification has been determined, the user device 100 selects a corresponding haptic effect for the category. In some examples, a correspondence between a notification and a haptic effect may be predetermined. For example, a user may be provided with the ability to select haptic effects for different notifications or events. In one example, a user can select a “phone call” event and be presented with haptic effects associated with the same category as the “phone call” event. In the example shown in FIG. 5, a phone call event is associated with a “now this” category and so the user may be able to select a haptic effect from the “now this” category of the framework. In some examples, a haptic effect may be selected dynamically. For example, a phone call notification or event may be used to identify a category and the user device 100 may then select a haptic effect from the corresponding category in the framework, e.g., based on a haptic effect identifier. In some examples, the user device 100 may select a haptic effect that does not otherwise satisfy all constraints of a category and scale up or down one or more characteristics of the haptic effect to satisfy each of the applicable constraints.

In some examples, the user device 100 may generate the haptic effect based on the device context as well. For example, if the device context indicates a quiet environment, the user device 100 may select a haptic effect based on the category of the notification, but may reduce a magnitude of the effect to minimize an impact on the quiet environment. Such a reduction of the magnitude may cause a strength of a haptic effect to be reduced, though remain within the constraints associated with the category of the haptic effect. Thus, a “now this” haptic effect may have its strength reduced to the lowest strength that still satisfies the constraints of the “now this” category in the framework. Or, in some examples, if the device determines that it is in an environment with a high amount of ambient vibrations, e.g., resulting from movement of a vehicle, the device 100 may increase a magnitude or frequency of a haptic effect to try to differentiate from the ambient vibrations. Again, the device 100 enforces the constraints on the category of the haptic effect based on the framework. Maintaining such constraints may provide for a consistent haptic experience for the user and enable the user to more quickly learn the haptic language associated with the framework.

At block 650, the user device 100 outputs the haptic effect to provide the notification. For example, the user device outputs the haptic effect using one or more of the haptic output devices 140, 190, such as to create a vibration or to change the shape of the device.

While some examples of methods and systems herein are described in terms of software executing on various machines, the methods and systems may also be implemented as specifically-configured hardware, such as field-programmable gate array (FPGA) specifically to execute the various methods. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs for editing an image. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable storage media, that may store instructions that, when executed by the processor, can cause the processor to perform the steps described herein as carried out, or assisted, by a processor. Examples of computer-readable media may include, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code for carrying out one or more of the methods (or parts of methods) described herein.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes all of the following alternative combinations as appropriate for a particular usage: A alone; B alone; C alone; A and B only; A and C only; B and C only; and A and B and C.

That which is claimed is:

1. A method comprising:
determining a context of a user device;
determining a notification to be provided by the user device;
determining a category of the notification;
generating a haptic effect based on the category of the notification; and
outputting the haptic effect to the user device.

2. The method of claim 1, wherein the category comprises one of a “now this” category, a “do this” category, a “know this” category, a “review this” category, or a “changed this” category.

3. The method of claim 1, wherein the generating the haptic effect comprises generating a haptic effect having a duration, an intensity, and a density.

4. The method of claim 3, wherein:
the duration comprises one of a short duration, a medium duration, or a long duration;
the intensity comprises one of a low intensity, a medium intensity, or a high intensity; and
the density comprises one of a low density, a medium density, or a high density.

5. The method of claim 4, wherein:
a short duration comprises a duration between approximately 0-1 second, a medium duration comprises a duration between approximately 1-4 seconds, and a long duration comprise a duration greater than approximately 4 seconds;
a low intensity comprises an intensity between approximately 0-6,000, a medium intensity comprises an intensity between approximately 6,000-8,000, and a high intensity comprises an intensity greater than approximately 8,000; and
a low density comprises a density between approximately 0-20%, a medium density comprises a density between approximately 20-80%, and a high density comprises a density greater than approximately 80%.

6. A method for generating one or more haptic effects, comprising:
receiving a selection of a category for a haptic effect, the category one of a plurality of predetermined categories of haptic effects;
obtaining a plurality of constraints for the haptic effect based on the selected category;
receiving an input indicating a characteristic of the haptic effect;
determining whether the characteristic violates any of the plurality of constraints;
responsive to determining that the characteristic violates at least one of the plurality of constraints, refusing the input; and
otherwise, modifying the haptic effect based on the input.

7. The method of claim 6, further comprising displaying an indication of the constraint that was violated.

8. The method of claim 6, wherein the category comprises one of a “now this” category, a “do this” category, a “know this” category, a “review this” category, or a “changed this” category.

9. The method of claim 6, wherein the characteristic of the haptic effect comprises one of a duration, an intensity, a density, or a rhythm.

10. The method of claim 9, wherein:
the duration comprises one of a short duration, a medium duration, or a long duration;
the intensity comprises one of a low intensity, a medium intensity, or a high intensity; and
the density comprises one of a low density, a medium density, or a high density.

11. The method of claim 10, wherein:
a short duration comprises a duration between approximately 0-1 second, a medium duration comprises a duration between approximately 1-4 seconds, and a long duration comprise a duration greater than approximately 4 seconds;
a low intensity comprises an intensity between approximately 0-6,000, a medium intensity comprises an intensity between approximately 6,000-8,000, and a high intensity comprises an intensity greater than approximately 8,000; and
a low density comprises a density between approximately 0-20%, a medium density comprises a density between approximately 20-80%, and a high density comprises a density greater than approximately 80%.

12. A system for generating one or more haptic effects, comprising:
a non-transitory computer-readable medium;
a processor in communication with the non-transitory computer-readable medium, the processor configured to execute program code stored in the non-transitory computer-readable medium to:
receive a selection of a category for a haptic effect, the category one of a plurality of predetermined categories of haptic effects;
obtain a plurality of constraints for the haptic effect based on the selected category;
receive an input indicating a characteristic of the haptic effect;
determine whether the characteristic violates any of the plurality of constraints; and
responsive to a determination that the characteristic violates at least one of the plurality of constraints, refuse the input.

13. The system of claim 12, wherein the processor is further configured to execute program code to cause a display device to display an indication of the constraint that was violated.

14. The system of claim 12, wherein the category comprises one of a “now this” category, a “do this” category, a “know this” category, a “review this” category, or a “changed this” category.

15. The system of claim 12, wherein the characteristic of the haptic effect comprises one of a duration, an intensity, a density, or a rhythm.

16. The system of claim 15, wherein:
the duration comprises one of a short duration, a medium duration, or a long duration;
the intensity comprises one of a low intensity, a medium intensity, or a high intensity; and
the density comprises one of a low density, a medium density, or a high density.

17. The system of claim 16, wherein:
a short duration comprises a duration between approximately 0-1 second, a medium duration comprises a duration between approximately 1-4 seconds, and a long duration comprise a duration greater than approximately 4 seconds;
a low intensity comprises an intensity between approximately 0-6,000, a medium intensity comprises an intensity between approximately 6,000-8,000, and a high intensity comprises an intensity greater than approximately 8,000; and
a low density comprises a density between approximately 0-20%, a medium density comprises a density between approximately 20-80%, and a high density comprises a density greater than approximately 80%.

18. A non-transitory computer-readable medium comprising processor-executable program code configured to cause the processor to:
receive a selection of a category for a haptic effect, the category one of a plurality of predetermined categories of haptic effects;
obtain a plurality of constraints for the haptic effect based on the selected category;
receive an input indicating a characteristic of the haptic effect;
determine whether the characteristic violates any of the plurality of constraints; and
responsive to a determination that the characteristic violates at least one of the plurality of constraints, refuse the input.

19. The non-transitory computer-readable medium of claim 18, wherein the program code is further configured to cause the processor to generate a display signal to cause an indication of the constraint that was violated to be displayed on a display device.

20. The non-transitory computer-readable medium of claim 18, wherein the category comprises one of a “now this” category, a “do this” category, a “know this” category, a “review this” category, or a “changed this” category.

21. The non-transitory computer-readable medium of claim 18, wherein the characteristic of the haptic effect comprises one of a duration, an intensity, a density, or a rhythm.

22. The non-transitory computer-readable medium of claim 21, wherein:
the duration comprises one of a short duration, a medium duration, or a long duration;
the intensity comprises one of a low intensity, a medium intensity, or a high intensity; and
the density comprises one of a low density, a medium density, or a high density.

23. The non-transitory computer-readable medium of claim 22, wherein:
a short duration comprises a duration between approximately 0-1 second, a medium duration comprises a duration between approximately 1-4 seconds, and a long duration comprise a duration greater than approximately 4 seconds;
a low intensity comprises an intensity between approximately 0-6,000, a medium intensity comprises an intensity between approximately 6,000-8,000, and a high intensity comprises an intensity greater than approximately 8,000; and
a low density comprises a density between approximately 0-20%, a medium density comprises a density between approximately 20-80%, and a high density comprises a density greater than approximately 80%.
